(19) United States
(12) Patent Application Publication
(10) Pub. No.: US 2026/0120073 A1
(43) Pub. Date: Apr. 30, 2026

(54) SEARCHING BUSINESSES FOR SUPPORTED PAYMENT METHODS

(71) Applicant: Motorola Mobility LLC, Chicago, IL (US)

(72) Inventors: Amit Kumar Agrawal, Bangalore (IN); Hariprasad Shanbhogue Alampady, Bengaluru (IN); Krishnan Raghavan, Bangalore (IN)

(73) Assignee: Motorola Mobility LLC, Chicago, IL (US)

(21) Appl. No.: 18/932,926

(22) Filed: Oct. 31, 2024

(51) Int. Cl. G06Q 20/32

(52) U.S. Cl. CPC G06Q 20/3223

(57) ABSTRACT

In aspects of searching businesses for supported payment methods, a mobile device searches for businesses in an environment. The mobile device receives indications of supported payment methods by one or more of the businesses. The mobile device compares digital banking payment methods available on the mobile device to the supported payment methods by the one or more businesses. The mobile device can also compare physical payment methods available with a user of the mobile device to the supported payment methods by the one or more businesses. The mobile device indicates the businesses that support at least one of the digital banking payment methods available on the mobile device, or the physical payment methods available with the user of the mobile device.

### BACKGROUND

Given the advancements in digital banking, many people no longer carry paper money, or even credit cards, opting rather for digital banking accounts that are accessible on a device, such as a mobile phone, portable computer, or any other type of electronic and/or computing device. Although digital banking payment methods can be accessible to a user on his or her mobile device, some business that offer goods and/or services may not accept one or more forms of digital payment from digital banking accounts that the user has setup on the mobile device.

### BRIEF DESCRIPTION OF THE DRAWINGS

Implementations of the techniques for searching businesses for supported payment methods are described with reference to the following Figures. The same numbers may be used throughout to reference like features and components shown in the Figures.

FIG. 1 illustrates an example system for searching businesses for supported payment methods in accordance with one or more implementations as described herein.

FIG. 2 illustrates examples of searching businesses for supported payment methods in accordance with one or more implementations as described herein.

FIGS. 3-5 illustrate example methods for searching businesses for supported payment methods in accordance with one or more implementations of the techniques described herein.

FIG. 6 illustrates various components of an example device that may be used to implement the techniques for searching businesses for supported payment methods as described herein.

### DETAILED DESCRIPTION

Implementations of the techniques for searching businesses for supported payment methods may be implemented as described herein. A mobile device, such as any type of a wireless device, media device, mobile phone, flip phone, client device, tablet, computing, communication, entertainment, gaming, media playback, and/or any other type of computing and/or electronic device, or a system of any combination of such devices, may be configured to perform techniques for searching businesses for supported payment methods as described herein. In one or more implementations, a mobile device includes a payment method manager, which can be used to implement aspects of the techniques described herein.

Conventionally, many people no longer carry paper money, or even credit cards, opting rather for digital banking accounts that are accessible on a mobile device. Although digital banking payment methods can be accessible to a user on his or her mobile device, some business that offer goods and/or services may not accept one or more forms of digital payment that the user has setup on the mobile device. This type of payment incompatibility may be particularly frustrating for the user when visiting a new city, or even traveling to a different country, and the digital banking payment methods are not accepted. For example, some retailers may only accept a Visa®-backed payment form of digital banking accounts, while not accepting Mastercard®-backed or American Express®-backed payment forms of digital banking accounts. These scenarios lead to poor user experiences, and can frustrate buyers who have invested time in shopping and selecting items, only to abandon them due to incompatible payment methods. In an unfamiliar location, this issue compounds as it disrupts plans, prompts rushed searches for alternatives, and detracts from the enjoyment of exploring new places. These poor user experiences highlight the need for seamless payment information accessibility in order to avoid awkward and time-consuming purchasing experiences.

Accordingly, the described techniques for searching businesses for supported payment methods provide that a user can be informed of the digital banking payment methods, as well as physical payment methods, that are supported by a retailer or business at the outset of the user starting a shopping experience, rather than after items have been selected for purchase and the shopper stands in line for payment. In one or more implementations, a user with a mobile device can initiate a search for businesses, such as on a city street or in another type of environment using the camera viewfinder of the device. The display screen of the mobile device can then display an augmented reality (AR) overlay of the businesses that support, or do not support, the digital banking payment methods available to the user on the mobile device and/or the physical payment methods that are available by the user of the mobile device.

In aspects of the described techniques, a user with a mobile device initiates a search for businesses and/or a category of specific merchandise, such as in local area. The mobile device includes the payment method manager that returns a set of the businesses, and receives a list of supported payment methods by each of the businesses. The payment method manager compares the list of supported payment methods by the businesses to the digital banking payment methods that are available on the mobile device. The payment method manager can then output or indicate (e.g., display) a filtered set of the businesses that support the digital banking payment methods available on the mobile device. Alternatively, or in addition, the payment method manager can output or indicate (e.g., display) a filtered set of the businesses that do not support the digital banking payment methods available on the mobile device.

In other aspects of the described techniques, the payment method manager can compare the list of supported payment methods by the businesses to the physical payment methods that are available with the user of the mobile device. The payment method manager can then output or indicate (e.g., display) a filtered set of the businesses that support the physical payment methods that are available with the user of the mobile device. Alternatively, or in addition, the payment method manager can output or indicate (e.g., display) a filtered set of the businesses that do not support the physical payment methods.

In other aspects of the described techniques, the payment method manager implemented on a mobile device can receive, such as from the user of the mobile device, an input designating a particular digital banking payment method, or a particular physical payment method. The payment method manager can then output or indicate (e.g., display) the set of the businesses that support the designated digital banking payment method or the physical payment method. This provides that a user can filter to show only the businesses that will accept a particular supported form of digital banking payment or physical from of payment. In other implementations, the payment method manager can generate a warning, such as a displayed warning on the mobile device, to indicate the user is entering a business that does not support any of the digital banking payment methods available on the mobile device and/or any of the physical payment methods that are available with the user of the mobile device. As described above, a user with a mobile device can initiate a search for businesses and/or a category of specific merchandise, such as in a local area, an environment, a city street, a shopping district, and the like. In one or more implementations, the user can initiate the search for businesses using the camera viewfinder of the device, and the payment method manager filters the businesses that accommodate and receive payment in the form of the digital banking payment methods available on the mobile device and/or the physical payment methods.

While features and concepts of the described techniques for searching businesses for supported payment methods is implemented in any number of different devices, systems, environments, and/or configurations, implementations of the techniques for searching businesses for supported payment methods are described in the context of the following example devices, systems, and methods.

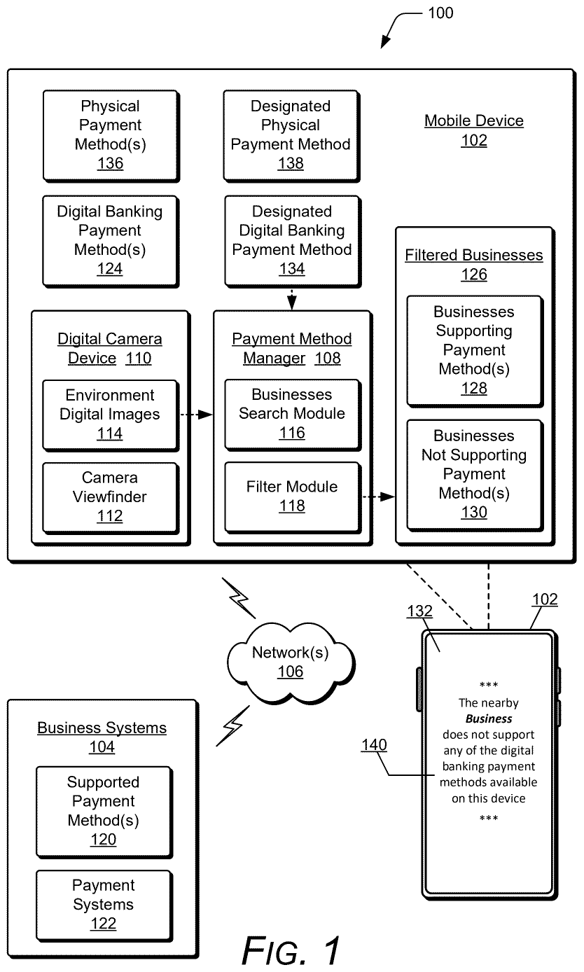

FIG. 1 illustrates an example system 100 for searching businesses for supported payment methods, as described herein. The system 100 includes a mobile device 102, various business systems 104 (e.g., retailers of goods and/or services), and a communication network 106. Examples of mobile device include any type of a wireless device, mobile device, mobile phone, flip phone, client device, companion device, tablet, computing device, communication device, entertainment device, gaming device, media playback device, any other type of computing, consumer, and/or electronic device.

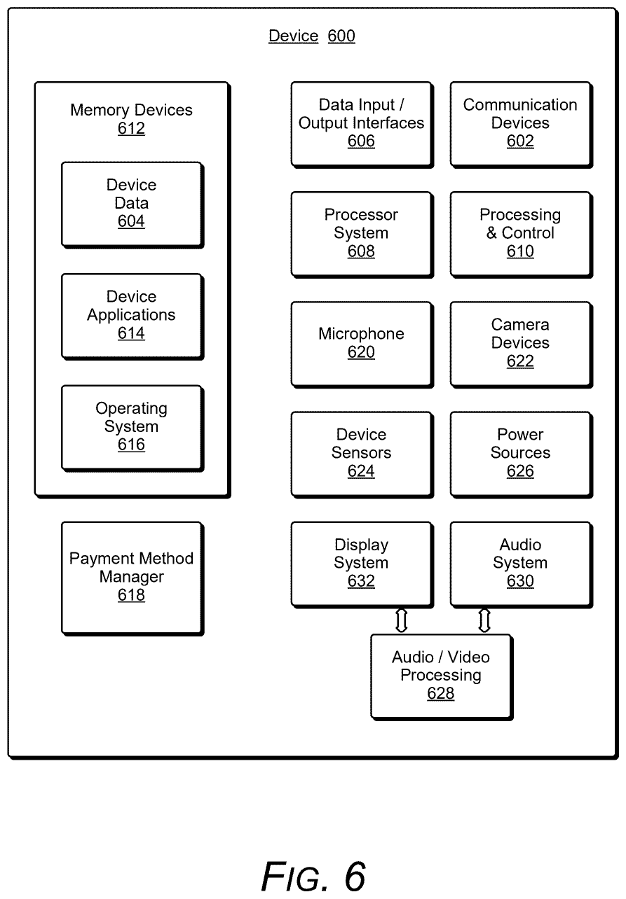

The mobile device 102 can be implemented with various components, such as a processor system and memory, as well as any number and combination of different components as further described with reference to the example device shown in FIG. 6. In implementations, the mobile device 102 includes various radios for wireless communication with other devices. For example, the system and devices can include a Bluetooth (BT) and/or Bluetooth Low Energy (BLE) transceiver, as well as a near field communication (NFC) transceiver. In some cases, the system and devices includes at least one of a WiFi radio, a cellular radio, a global positioning satellite (GPS) radio, or any available type of device communication interface.

In some implementations, the devices, applications, modules, servers, and/or services described herein communicate via the communication network 106, such as for data communication with the mobile device 102. The communication network 106 includes a wired and/or a wireless network. The communication network 106 is implemented using any type of network topology and/or communication protocol, and is represented or otherwise implemented as a combination of two or more networks, to include IP-based networks, cellular networks, and/or the Internet. The communication network 106 includes mobile operator networks that are managed by a mobile network operator and/or other network operators, such as a communication service provider, mobile phone provider, and/or Internet service provider.

The mobile device 102 includes various functionality that enables the device to implement different aspects of searching businesses for supported payment methods, as described herein. In one or more examples, an interface module represents functionality (e.g., logic and/or hardware) enabling the mobile device 102 to interconnect and interface with other devices and/or networks, such as the communication network 106 and/or the various business systems 104. For example, the interface module enables wireless and/or wired connectivity of the mobile device 102.

The mobile device 102 can include and implement various device applications, such as any type of messaging application, email application, video communication application, cellular communication application, music/audio application, gaming application, media application, social platform applications, and/or any other of the many possible types of various device applications. Many of the device applications have an associated application user interface that is generated and displayed for user interaction and viewing, such as on a display screen of the mobile device 102. Generally, an application user interface, or any other type of video, image, graphic, and the like is digital image content that is displayable on the display screen of the mobile device 102.

In the example system 100 for searching businesses for supported payment methods, the mobile device 102 implements a payment method manager 108 (e.g., as a device application). As shown in this example, the payment method manager 108 represents functionality (e.g., logic, software, and/or hardware) enabling aspects of the described techniques for searching businesses for supported payment methods. The payment method manager 108 can be implemented as computer instructions stored on computer-readable storage media and can be executed by a processor system of the mobile device 102. Alternatively, or in addition, the payment method manager 108 can be implemented at least partially in hardware of the device.

In one or more implementations, the payment method manager 108 includes independent processing, memory, and/or logic components functioning as a computing and/or electronic device integrated with the mobile device 102. Alternatively, or in addition, the payment method manager 108 can be implemented in software, in hardware, or as a combination of software and hardware components. In this example, the payment method manager 108 is implemented as a software application or module, such as executable software instructions (e.g., computer-executable instructions) that are executable with a processor system of the mobile device 102 to implement the techniques and features described herein. As a software application or module, the payment method manager 108 can be stored on computer-readable storage memory (e.g., memory of a device), or in any other suitable memory device or electronic data storage implemented with the manager or a controller. Alternatively or in addition, the payment method manager 108 is implemented in firmware and/or at least partially in computer hardware. For example, at least part of the payment method manager 108 is executable by a computer processor, and/or at least part of the content manager is implemented in logic circuitry.

In this example system 100, the mobile device 102 includes a digital camera device 110, such as a rear-facing camera and/or a front-facing camera. A user of the mobile device 102 can initiate a search for businesses and/or a category of specific merchandise, such as in an environment (e.g., a local area, a city street, a shopping district, and the like). In one or more implementations, the user can initiate the search for businesses using the camera viewfinder 112 of the mobile device 102, and capture video and/or digital images 114 of the environment. The digital images 114 may include any type of still images, motion-enhanced images, images extracted from video, and the like.

In this example system 100, the payment method manager 108 of the mobile device 102 includes a businesses search module 116 and a filter module 118. The businesses search module 116 receives the digital images 114 of the environment from the digital camera device 110, and the businesses search module 116 searches for businesses that are detectable in the digital images. In implementations, the payment method manager 108, along with the businesses search module 116 and/or the filter module 118, may be implemented using any one or more of a variety of different public or proprietary machine learning models trained to identify the businesses as described above, such as from the digital images 114 of the environment, or by other techniques. Machine learning models refer to a computer representation that can be tuned (e.g., trained) based on inputs to approximate unknown functions. In particular, machine learning models can utilize algorithms to learn from, and make predictions on, known data by analyzing the known data to learn to generate outputs that reflect patterns and attributes of the known data. For instance, a machine learning model of the payment method manager 108 can include decision trees, support vector machines, linear regression, logistic regression, Bayesian networks, random forest learning, dimensionality reduction algorithms, boosting algorithms, artificial neural networks, deep learning, and so forth.

The businesses search module 116 of the payment method manager 108 can generate and/or return a set of identified businesses, such as determined in the environment (e.g., a local area, a city street, a shopping district, and the like) as initiated by the user of the mobile device 102. The payment method manager 108 also receives a list or indications of supported payment methods 120 from the business systems 104 (e.g., of the identified businesses in the environment). The mobile device 102 can receive the list or indications of the supported payment methods 120 via the communication network 106 from the business systems 104 and/or from payment systems 122 that are internal and/or external to the businesses and/or the business systems.

The filter module 118 of the payment method manager 108 can compare the list or indications of the supported payment methods 120 by the businesses to the digital banking payment methods 124 that are available on the mobile device 102. In an example, the digital banking payment methods 124 are forms of digital payment that the user has setup on the mobile device. The payment method manager 108 can then output or indicate (e.g., display) a set of filtered businesses 126, which includes the businesses (at 128) that support the digital banking payment methods 124 available on the mobile device. The set of filtered businesses 126 can also include the businesses (at 130) that do not support the digital banking payment methods 124 available on the mobile device.

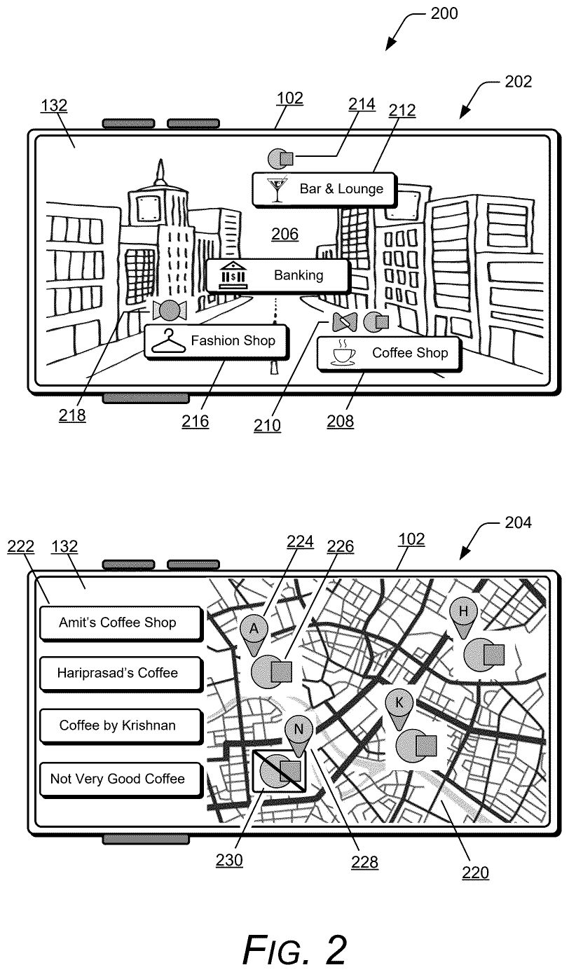

In one or more implementations, the payment method manager 108 can initiate to display the businesses (e.g., as related to the business systems 104) and indicate the businesses that support the digital banking payment methods 124 available on the mobile device 102. For example, the mobile device 102 includes a display device 132 on which the businesses in the environment can be displayed, as well as indications of the businesses that support the digital banking payment methods 124 available on the mobile device and/or the businesses that do not support the digital banking payment methods available on the mobile device. Examples of these implementations are further shown and described with reference to FIG. 2.

In one or more implementations, the payment method manager 108 of the mobile device 102 can receive an input of a designated digital banking payment method (at 134), such as designated by a user of the mobile device. For example, the user of the mobile device can select one (or more) of the digital banking payment methods 124 that are available on the mobile device. The payment method manager 108 can then initiate to display the businesses (e.g., as related to the business systems 104) and indicate the businesses that specifically support the designated digital banking payment method. In implementations, the display device 132 of the mobile device can display the environment and augmented reality over the environment of the businesses that support the designated digital banking payment method.

In additional implementations, the filter module 118 of the payment method manager 108 can compare the list or indications of the supported payment methods 120 by the businesses to physical payment methods 136 that are available with a user of the mobile device 102. In an example, the physical payment methods 136 can be debit cards, credit cards, or other types of physical payment forms that are backed by banking or finance institutions. These physical payment methods 136 can be determined or attained by the mobile device 102 (e.g., and the payment method manager 108) based on transactions that the user has initiated with any of the physical debit or credit cards, where information of the transactions is communicated to the mobile device 102, either in the form of security (e.g., seeking a OTP (one time password) or for two-factor authentication) to complete a transaction, or as transaction details via SMS, email, or other forms of transaction receipt notifications. The payment method manager 108 can then output or indicate (e.g., display) a set of filtered businesses 126, which includes the businesses (at 128) that support the physical payment methods 136 that are available from a user of the mobile device. The set of filtered businesses 126 can also include the businesses (at 130) that do not support the physical payment methods 136.

In one or more implementations, the payment method manager 108 can initiate to display the businesses (e.g., as related to the business systems 104) and indicate the businesses that support the physical payment methods 136 that are available from the user of the mobile device 102. For example, the display device 132 of the mobile device 102 can display the businesses in the environment, as well as indications of the businesses that support the physical payment methods 136 that are available with the user of the mobile device and/or the businesses that do not support the physical payment methods.

In one or more implementations, the payment method manager 108 of the mobile device 102 can receive an input of a designated physical payment method (at 138), such as designated by a user of the mobile device. For example, the user of the mobile device can indicate one (or more) of the physical payment methods 136 that are physically available with the user for point-of-sale transactions. The payment method manager 108 can then initiate to display the businesses (e.g., as related to the business systems 104) and indicate the businesses that specifically support the designated physical payment method. In implementations, the display device 132 of the mobile device can display the environment and augmented reality over the environment of the businesses that support the designated physical payment method.

In other implementations, the payment method manager 108 of the mobile device 102 can initiate to output a warning display 140 on the display device 132 of the mobile device to indicate proximity of a business that does not support any of the digital banking payment methods 124 that are available on the mobile device. Alternatively or in addition, the payment method manager 108 of the mobile device 102 can initiate to output a warning display 140 on the display device 132 to indicate proximity of a business that does not support any of the physical payment methods 136 that are available with the user of the mobile device. This feature can help a user avoid an uncomfortable and/or time-consuming experience by letting the user know that a particular business where the user may be shopping or seeking to purchase an item does not support any of the physical payment methods 136 or the digital banking payment methods 124 that are available on the mobile device of the user.

FIG. 2 illustrates examples 200 of searching businesses for supported payment methods, as described herein. These examples 200 illustrate features that can be displayed on the display device 132 of the mobile device 102, such as interfaces that depict businesses which are determined and filtered to support the digital banking payment methods 124 available on the mobile device of the user. An example 202 illustrates an augmented reality (AR) view of different businesses or retailers and indications of the types of digital banking payment methods that are supported by each of the different businesses. An example 204 illustrates a different logistic view of businesses that offer a specific product category, such as coffee, along with the indications of a designated digital banking payment method supported by the businesses.

In the example 202, a user of the mobile device 102 has initiated a search for businesses in an environment 206 (e.g., a local area, a city street, a shopping district, and the like). The AR display includes indications of the businesses in the environment 206, as well as the types of the digital banking payment methods that are supported by a particular business. For example, a first business 208 is a coffee shop that supports two types of the digital banking payment methods 124 that are available on the mobile device 102. In this example, the two types of the digital banking payment methods 124 are indicated by logos 210, such as logos associated with particular financial companies that back payment forms of digital banking accounts and/or credit cards. Another business 212, such as a bar and lounge, supports one type of the digital banking payment methods 124 available on the mobile device 102. Notably, the business 212 supports one of the same payment methods as the first business 208, as indicated by the financial company logo 214. Another business 216, such as a fashion shop (e.g., clothing boutique), also supports one type of the digital banking payment methods 124 available on the mobile device 102. In this example, the business 216 supports a different form of digital banking accounts and/or credit cards, as indicated by the different financial company logo 218.

In the example 204, a user of the mobile device 102 has initiated a search for businesses that offer a particular category of product, such as coffee. The AR display includes a map of an environment 220 with indications of the businesses in the environment that offer the particular product category and that support a designated digital banking payment method available on the mobile device 102. For example, in addition to initiating the search for nearby businesses that offer coffee, the user of the mobile device may also designate a particular one of the digital banking payment methods 124 that are available on the mobile device. In this example, four businesses that offer coffee are identified in a list 222 and also indicated in the AR display (e.g., at 224), along with a designation 226 of the requested type of digital banking payment method that is supported by the businesses. The designation 226 of the requested type of the digital banking payment method is indicated as a financial company logo displayed next to all of the determined businesses that support the form of payment. This example also indicates the location of a business 228 that does not support the requested type of the digital banking payment method, such as indicated with a crossed-out logo 230, or any other type of indication.

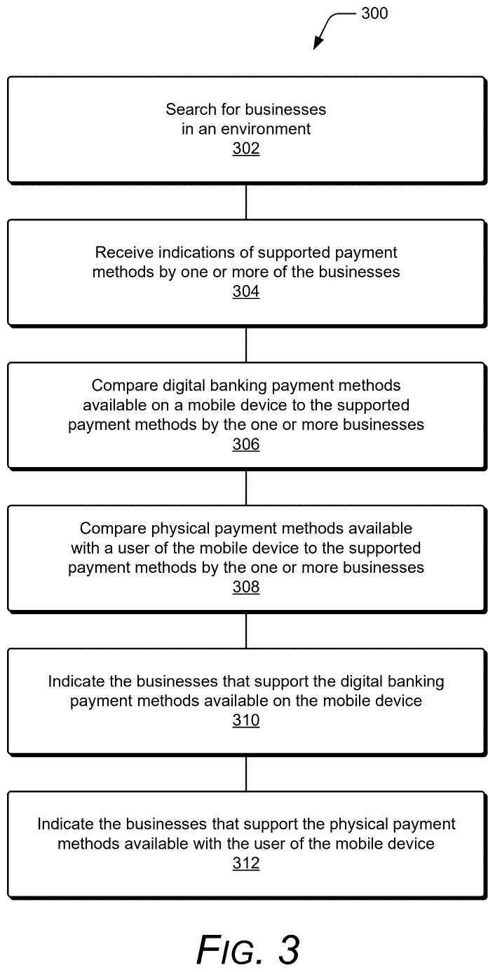

Example methods 300, 400, and 500 are described with reference to respective FIGS. 3, 4, and 5 in accordance with one or more implementations of searching businesses for supported payment methods, as described herein. Generally, any services, components, modules, managers, controllers, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 3 illustrates example method(s) 300 for searching businesses for supported payment methods. The order in which the method is described is not intended to be construed as a limitation, and any number or combination of the described method operations may be performed in any order to perform a method, or an alternate method.

At 302, businesses are searched for in an environment. For example, the businesses search module 116 of the payment method manager 108 receives the digital images 114 of the environment from the digital camera device 110, and the businesses search module 116 searches for businesses that are detectable in the digital images. In one or more implementations, the user can initiate a search for businesses using the camera viewfinder 112 of the mobile device 102, and capture video and/or digital images 114 of the environment. The digital images 114 may include any type of still images, motion-enhanced images, images extracted from video, and the like.

At 304, indications are received of supported payment methods by one or more of the businesses. For example, the payment method manager 108 receives a list or indications of supported payment methods 120 from the business systems 104 (e.g., of the identified businesses in the environment). The mobile device 102 receives the list or indications of the supported payment methods 120 via the communication network 106 from the business systems 104 and/or from payment systems 122 that are internal and/or external to the businesses and/or the business systems.

At 306, digital banking payment methods available on a mobile device are compared to the supported payment methods by the one or more businesses. For example, the filter module 118 of the payment method manager 108 compares the list or indications of the supported payment methods 120 by the businesses to the digital banking payment methods 124 that are available on the mobile device 102.

At 308, physical payment methods available with a user of the mobile device are compared to the supported payment methods by the one or more businesses. For example, the filter module 118 of the payment method manager 108 compares the list or indications of the supported payment methods 120 by the businesses to the physical payment methods 136 that a user of the mobile device 102 has available or is carrying.

At 310, the businesses that support the digital banking payment methods available on the mobile device are indicated. For example, the payment method manager 108 outputs or indicates (e.g., displays) a set of filtered businesses 126, which includes the businesses that support the digital banking payment methods 124 available on the mobile device. The set of filtered businesses 126 can also include the businesses that do not support the digital banking payment methods 124 available on the mobile device.

At 312, the businesses that support the physical payment methods available with a user of the mobile device are indicated. For example, the payment method manager 108 outputs or indicates (e.g., displays) a set of filtered businesses 126, which includes the businesses that support the physical payment methods 136 that a user of the mobile device 102 has available or is carrying. The set of filtered businesses 126 can also include the businesses that do not support the physical payment methods 124 that are available with the user.

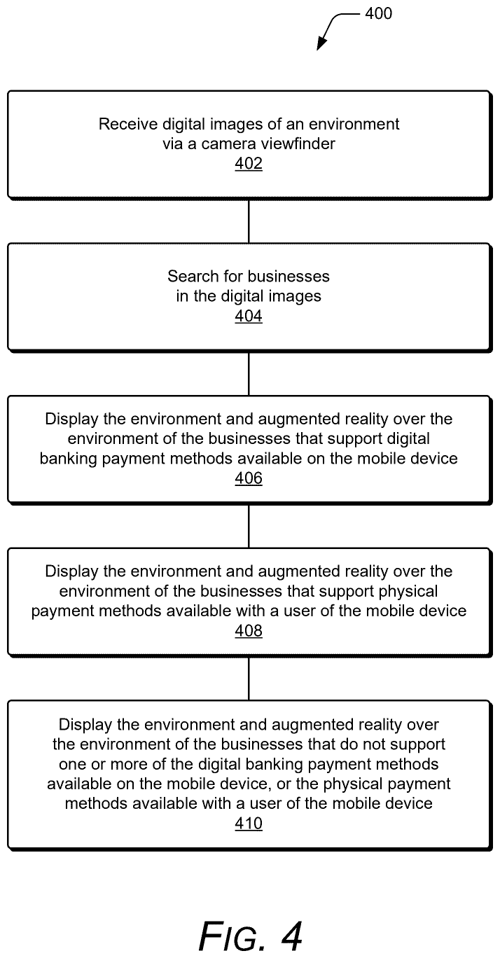

FIG. 4 illustrates example method(s) 400 for searching businesses for supported payment methods. The order in which the method is described is not intended to be construed as a limitation, and any number or combination of the described method operations may be performed in any order to perform a method, or an alternate method.

At 402, digital images of an environment are received via a camera viewfinder. For example, the businesses search module 116 of the payment method manager 108 receives the digital images 114 of the environment from the digital camera device 110. In one or more implementations, a user of the mobile device 102 can initiate a search for businesses using the camera viewfinder 112 of the mobile device, and capture video and/or digital images 114 of the environment.

At 404, the businesses are searched for in the digital images. For example, the businesses search module 116 of the payment method manager 108 searches for businesses that are detectable in the digital images. The digital images 114 may include any type of still images, motion-enhanced images, images extracted from video, and the like.

At 406, the environment is displayed with augmented reality over the environment of the businesses that support the digital banking payment methods available on the mobile device. For example, the payment method manager 108 initiates to display the businesses (e.g., as related to the business systems 104) and indicates the businesses that support the digital banking payment methods 124 available on the mobile device 102. In one or more implementations, the mobile device displays the environment and AR over the environment to indicate the businesses that support the digital banking payment methods available on the mobile device.

At 408, the environment is displayed with augmented reality over the environment of the businesses that support the physical payment methods available with a user of the mobile device. For example, the payment method manager 108 initiates to display the businesses (e.g., as related to the business systems 104) and indicates the businesses that support the physical payment methods 136 that a user of the mobile device 102 has available or is carrying. In one or more implementations, the mobile device 102 displays the environment and AR over the environment to indicate the businesses that support the physical payment methods available with the user of the mobile device.

At 410, the environment is displayed with augmented reality over the environment of the businesses that do not support one or more of the digital banking payment methods available on the mobile device, or the physical payment methods available with a user of the mobile device. For example, the payment method manager 108 initiates to display the businesses (e.g., as related to the business systems 104) and indicates the businesses that do not support one or more of the digital banking payment methods 124 available on the mobile device 102, or the physical payment methods 136 available with a user of the mobile device. In one or more implementations, the mobile device 102 displays the environment and AR over the environment of the businesses that do not support the digital banking payment methods available on the mobile device and the physical payment methods available with the user of the mobile device.

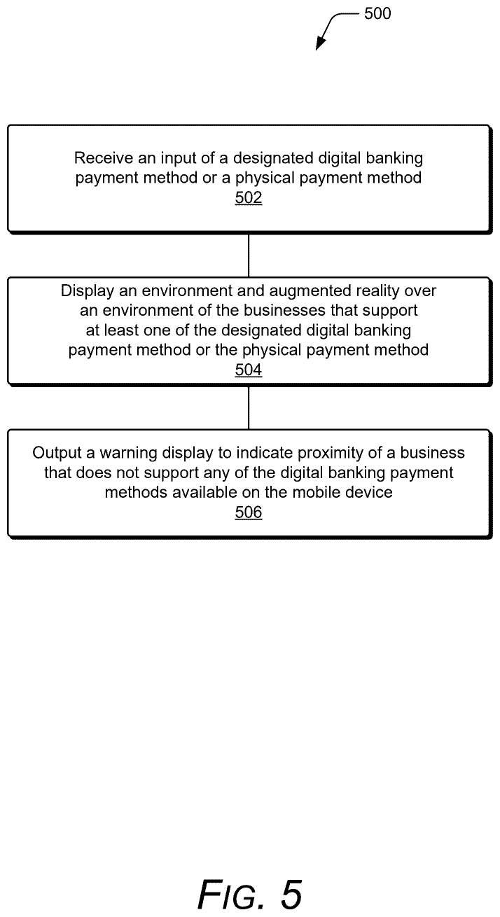

FIG. 5 illustrates example method(s) 500 for searching businesses for supported payment methods. The order in which the method is described is not intended to be construed as a limitation, and any number or combination of the described method operations may be performed in any order to perform a method, or an alternate method.

At 502, an input of a designated digital banking payment method or a physical payment method is received. For example, the payment method manager 108 of the mobile device 102 receives an input of a designated digital banking payment method (at 134), such as designated by a user of the mobile device. Alternatively, the payment method manager 108 may receive an input of a physical payment method that the user of the mobile device has available, such as designated by the user of the mobile device. For example, the user of the mobile device can select one (or more) of the digital banking payment methods 124 that are available on the mobile device, or select one (or more) of the physical payment methods 136 that the user has available or is carrying.

At 504, the environment is displayed with augmented reality over the environment of the businesses that support at least one of the designated digital banking payment method or the physical payment method. For example, the display device 132 of the mobile device 102 displays the environment and AR over the environment to indicate the businesses that support the designated digital banking payment method available on the mobile device, and/or to indicate the businesses that support the physical payment method that is available to the user of the mobile device, as designated by the user of the device.

At 506, a warning display is displayed to indicate proximity of a business that does not support any of the digital banking payment methods available on the mobile device. For example, the display device 132 of the mobile device 102 displays the environment and AR over the environment to indicate the businesses that do not support the digital banking payment methods 124 available on the mobile device. The display of the environment and AR over the environment may also indicate the businesses that do not support the physical payment methods 136 that are available to the user of the mobile device.

FIG. 6 illustrates various components of an example device 600, which can implement aspects of the techniques and features for searching businesses for supported payment methods, as described herein. The example device 600 may be implemented as any of the devices described with reference to the previous FIGS. 1-5, such as any type of a wireless device, mobile device, mobile phone, flip phone, client device, companion device, display device, tablet, computing, communication, entertainment, gaming, media playback, and/or any other type of computing, consumer, and/or electronic device. For example, the mobile device 102 and/or the business systems 104 described with reference to FIGS. 1-5 may be implemented as the example device 600.

The example device 600 can include various, different communication devices 602 that enable wired and/or wireless communication of device data 604 with other devices. The device data 604 can include any of the various devices data and content that is generated, processed, determined, received, stored, and/or communicated from one computing device to another. Generally, the device data 604 can include any form of audio, video, image, graphics, and/or electronic data that is generated by applications executing on a device. The communication devices 602 can also include transceivers for cellular phone communication and/or for any type of network data communication.

The example device 600 can also include various, different types of data input/output (I/O) interfaces 606, such as data network interfaces that provide connection and/or communication links between the devices, data networks, and other devices. The data I/O interfaces 606 may be used to couple the device to any type of components, peripherals, and/or accessory devices, such as a computer input device that may be integrated with the example device 600. The I/O interfaces 606 may also include data input ports via which any type of data, information, media content, communications, messages, and/or inputs may be received, such as user inputs to the device, as well as any type of audio, video, image, graphics, and/or electronic data received from any content and/or data source.

The example device 600 includes a processor system 608 of one or more processors (e.g., any of microprocessors, controllers, and the like) and/or a processor and memory system implemented as a system-on-chip (SoC) that processes computer-executable instructions. The processor system 608 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device may be implemented with any one or combination of software, hardware, firmware, or fixed logic circuitry that may be implemented in connection with processing and control circuits, which are generally identified at 610. The example device 600 may also include any type of a system bus or other data and command transfer system that couples the various components within the device. A system bus can include any one or combination of different bus structures and architectures, as well as control and data lines.

The example device 600 also includes memory and/or memory devices 612 (e.g., computer-readable storage memory) that enable data storage, such as data storage devices implemented in hardware which may be accessed by a computing device, and that provide persistent storage of data and executable instructions (e.g., software applications, programs, functions, and the like). Examples of the memory devices 612 include volatile memory and non-volatile memory, fixed and removable media devices, and any suitable memory device or electronic data storage that maintains data for computing device access. The memory devices 612 can include various implementations of random-access memory (RAM), read-only memory (ROM), flash memory, and other types of storage media in various memory device configurations. The example device 600 may also include a mass storage media device.

The memory devices 612 (e.g., as computer-readable storage memory) provide data storage mechanisms, such as to store the device data 604, other types of information and/or electronic data, and various device applications 614 (e.g., software applications and/or modules). For example, an operating system 616 may be maintained as software instructions with a memory device 612 and executed by the processor system 608 as a software application. The device applications 614 may also include a device manager, such as any form of a control application, software application, signal-processing and control module, code that is specific to a particular device, a hardware abstraction layer for a particular device, and so on.

In this example, the device 600 includes a payment method manager 618 that implements various aspects of the described features and techniques described herein. The payment method manager 618 may be implemented with hardware components and/or in software as one of the device applications 614, such as when the example device 600 is implemented as the mobile device 102 described with reference to FIGS. 1-5. An example of the payment method manager 618 is the payment method manager 108 implemented by the mobile device 102, such as a software application and/or as hardware components in the mobile device. In implementations, the payment method manager 618 may include independent processing, memory, and logic components as a computing and/or electronic device integrated with the example device 600.

The example device 600 can also include a microphone 620 (e.g., to capture an audio recording of a user or environment) and/or camera devices 622 (e.g., to capture video and/or digital images of the user or environment), as well as device sensors 624, such as may be implemented as components of an inertial measurement unit (IMU). The device sensors 624 may be implemented with various sensors, such as a gyroscope, an accelerometer, and/or other types of motion sensors to sense motion of the device. The device sensors 624 can generate sensor data vectors having three-dimensional parameters (e.g., rotational vectors in x, y, and z-axis coordinates) indicating location, position, acceleration, rotational speed, and/or orientation of the device. The example device 600 can also include one or more power sources 626, such as when the device is implemented as a wireless device and/or a mobile device. The power sources may include a charging and/or power system, and may be implemented as a flexible strip battery, a rechargeable battery, a charged super-capacitor, and/or any other type of active or passive power source.

The example device 600 can also include an audio and/or video processing system 628 that generates audio data for an audio system 630 and/or generates display data for a display system 632. The audio system and/or the display system may include any types of devices or modules that generate, process, display, and/or otherwise render audio, video, display, and/or image data. Display data and audio signals may be communicated to an audio component and/or to a display component via any type of audio and/or video connection or data link. In implementations, the audio system and/or the display system are integrated components of the example device 600. Alternatively, the audio system and/or the display system are external, peripheral components to the example device.

Although implementations for searching businesses for supported payment methods have been described in language specific to features and/or methods, the appended claims are not necessarily limited to the specific features or methods described. Rather, the specific features and methods are disclosed as example implementations for searching businesses for supported payment methods, and other equivalent features and methods are intended to be within the scope of the appended claims. Further, various different examples are described, and it is to be appreciated that each described example may be implemented independently or in connection with one or more other described examples. Additional aspects of the techniques, features, and/or methods discussed herein relate to one or more of the following:

A mobile device, comprising: at least one memory; and at least one processor coupled with the at least one memory and configured to cause the mobile device to: search for businesses in an environment; receive indications of supported payment methods by one or more of the businesses; compare digital banking payment methods available on the mobile device to the supported payment methods by the one or more businesses; and indicate the businesses that support the digital banking payment methods available on the mobile device.

Alternatively, or in addition to the above-described mobile device, any one or combination of: the at least one processor is configured to cause the mobile device to compare physical payment methods available with a user of the mobile device to the supported payment methods by the one or more businesses; and indicate the businesses that support the physical payment methods available with the user of the mobile device. The at least one processor is configured to cause the mobile device to receive digital images of the environment via a camera viewfinder, and search for the businesses in the digital images. The at least one processor is configured to cause the mobile device to display the businesses, wherein the businesses provide at least one of goods or services for purchase using one or more of the digital banking payment methods available on the mobile device; and indicate the one or more businesses that support the digital banking payment methods available on the mobile device. The at least one processor is configured to cause the mobile device to display the environment and augmented reality over the environment of the businesses that support the digital banking payment methods available on the mobile device. The at least one processor is configured to cause the mobile device to display the environment and augmented reality over the environment of the businesses that do not support the digital banking payment methods available on the mobile device. The at least one processor is configured to cause the mobile device to receive an input of a designated digital banking payment method. The at least one processor is configured to cause the mobile device to display the environment and augmented reality over the environment of the businesses that support the designated digital banking payment method. The at least one processor is configured to cause the mobile device to output a warning display to indicate proximity of a business that does not support any of the digital banking payment methods available on the mobile device.

A method, comprising: searching for businesses in an environment; receiving indications of supported payment methods by one or more of the businesses; comparing digital banking payment methods available on a mobile device to the supported payment methods by the one or more businesses; and indicating the businesses that support the digital banking payment methods available on the mobile device.

Alternatively, or in addition to the above-described method, any one or combination of: the method further comprising comparing physical payment methods available with a user of the mobile device to the supported payment methods by the one or more businesses; and indicating the businesses that support the physical payment methods available with the user of the mobile device. The method further comprising receiving digital images of the environment via a camera viewfinder, and searching for the businesses in the digital images. The method further comprising displaying the businesses, wherein the businesses provide at least one of goods or services for purchase using one or more of the digital banking payment methods available on the mobile device; and indicating the one or more businesses that support the digital banking payment methods available on the mobile device. The further comprising displaying the environment and augmented reality over the environment of the businesses that support the digital banking payment methods available on the mobile device. The further comprising displaying the environment and augmented reality over the environment of the businesses that do not support the digital banking payment methods available on the mobile device. The method further comprising receiving an input of a designated digital banking payment method. The method further comprising displaying the environment and augmented reality over the environment of the businesses that support the designated digital banking payment method. The method further comprising outputting a warning display to indicate proximity of a business that does not support any of the digital banking payment methods available on the mobile device.

A system, comprising: a payment method manager configured to compare at least one of digital banking payment methods available on a mobile device to supported payment methods by businesses in an environment; or physical payment methods available with a user of the mobile device to the supported payment methods by the businesses; and a display device to display one or more of the businesses that at least one of support the digital banking payment methods available on the mobile device or the physical payment methods available with the user of the mobile device.

Alternatively, or in addition to the above-described system, any one or combination of: the payment method manager is configured to receive an input of at least one of a designated digital banking payment method or a physical payment method; and display the environment and augmented reality over the environment of the businesses that support at least one of the designated digital banking payment method or the physical payment method.

1. A mobile device, comprising:
at least one memory; and
at least one processor coupled with the at least one memory and configured to cause the mobile device to:
search for businesses in an environment;
receive indications of supported payment methods by one or more of the businesses;
compare digital banking payment methods available on the mobile device to the supported payment methods by the one or more businesses; and
indicate the businesses that support the digital banking payment methods available on the mobile device.

2. The mobile device of claim 1, wherein the at least one processor is configured to cause the mobile device to:
compare physical payment methods available with a user of the mobile device to the supported payment methods by the one or more businesses; and
indicate the businesses that support the physical payment methods available with the user of the mobile device.

3. The mobile device of claim 1, wherein the at least one processor is configured to cause the mobile device to receive digital images of the environment via a camera viewfinder, and search for the businesses in the digital images.

4. The mobile device of claim 1, wherein the at least one processor is configured to cause the mobile device to:
display the businesses, wherein the businesses provide at least one of goods or services for purchase using one or more of the digital banking payment methods available on the mobile device; and
indicate the one or more businesses that support the digital banking payment methods available on the mobile device.

5. The mobile device of claim 1, wherein the at least one processor is configured to cause the mobile device to display the environment and augmented reality over the environment of the businesses that support the digital banking payment methods available on the mobile device.

6. The mobile device of claim 1, wherein the at least one processor is configured to cause the mobile device to display the environment and augmented reality over the environment of the businesses that do not support the digital banking payment methods available on the mobile device.

7. The mobile device of claim 1, wherein the at least one processor is configured to cause the mobile device to receive an input of a designated digital banking payment method.

8. The mobile device of claim 7, wherein the at least one processor is configured to cause the mobile device to display the environment and augmented reality over the environment of the businesses that support the designated digital banking payment method.

9. The mobile device of claim 1, wherein the at least one processor is configured to cause the mobile device to output a warning display to indicate proximity of a business that does not support any of the digital banking payment methods available on the mobile device.

10. A method, comprising:
searching for businesses in an environment;
receiving indications of supported payment methods by one or more of the businesses;
comparing digital banking payment methods available on a mobile device to the supported payment methods by the one or more businesses; and
indicating the businesses that support the digital banking payment methods available on the mobile device.

11. The method of claim 10, further comprising:
comparing physical payment methods available with a user of the mobile device to the supported payment methods by the one or more businesses; and
indicating the businesses that support the physical payment methods available with the user of the mobile device.

12. The method of claim 10, further comprising receiving digital images of the environment via a camera viewfinder, and searching for the businesses in the digital images.

13. The method of claim 10, further comprising:
displaying the businesses, wherein the businesses provide at least one of goods or services for purchase using one or more of the digital banking payment methods available on the mobile device; and
indicating the one or more businesses that support the digital banking payment methods available on the mobile device.

14. The method of claim 10, further comprising displaying the environment and augmented reality over the environment of the businesses that support the digital banking payment methods available on the mobile device.

15. The method of claim 10, further comprising displaying the environment and augmented reality over the environment of the businesses that do not support the digital banking payment methods available on the mobile device.

16. The method of claim 10, further comprising receiving an input of a designated digital banking payment method.

17. The method of claim 16, further comprising displaying the environment and augmented reality over the environment of the businesses that support the designated digital banking payment method.

18. The method of claim 10, further comprising outputting a warning display to indicate proximity of a business that does not support any of the digital banking payment methods available on the mobile device.

19. A system, comprising:
a payment method manager configured to compare at least one of:
digital banking payment methods available on a mobile device to supported payment methods by businesses in an environment; or
physical payment methods available with a user of the mobile device to the supported payment methods by the businesses; and
a display device to display one or more of the businesses that at least one of support the digital banking payment methods available on the mobile device or the physical payment methods available with the user of the mobile device.

20. The system of claim 19, wherein the payment method manager is configured to:
receive an input of at least one of a designated digital banking payment method or a physical payment method; and
display the environment and augmented reality over the environment of the businesses that support at least one of the designated digital banking payment method or the physical payment method.
